(19) United States
(12) Patent Application Publication
(10) Pub. No.: US 2015/0237427 A1
(43) Pub. Date: Aug. 20, 2015

(54) SPEAKER

(71) Applicant: H.P. SOUND EQUIPMENT S.P.A., San Piero a Sieve- Firenze (IT)

(72) Inventor: Alessandro Tatini, Fiesole-Firenze (IT)

(21) Appl. No.: 14/429,790

(22) PCT Filed: Oct. 9, 2013
(86) PCT No.: PCT/IT2013/000274

§ 371 Date: Mar. 20, 2015

(30) Foreign Application Priority Data
Oct. 13, 2012 (IT) FI2012U000061

(51) Int. Cl. H04R 1/02

(52) U.S. Cl. CPC H04R 1/02

(57) ABSTRACT

Disclosed is an acoustic speaker (1) including a plurality of loudspeakers (10), a flexible element (2) for supporting the loudspeakers, and a flexible sheath (5) for external coating of the loudspeakers and the flexible supporting element.

### TECHNICAL SECTOR

The present invention relates to a speaker of the type comprising a plurality of loudspeakers arranged in line.

### PRIOR ART

Many examples of linear speakers are known of the type used for diffusion of sound in closed environments or in the open.

This type of speakers is generally constituted by a rigid rectilinear container, housed within which is a certain number of loudspeakers.

Speakers with this configuration are commonly wall-mounted or mounted on appropriate pedestals and oriented so as to emit the sound in the desired directions.

There are moreover known linear speakers comprising a number of rigid containers connected together.

These speakers find application where it is desirable to orient differently the cone of acoustic emission of the loudspeakers, for example at different heights with respect to the audience.

Known speakers are consequently of a rigid type and have a rectilinear geometry, but cannot assume a curved geometry of variable shape.

The limits of the systems of a known type hence entail the impossibility of using acoustic speakers in those applications that require curved geometries and the capacity to adapt to different shapes during use.

For instance, in one and the same circumstance it may be desirable to apply one and the same speaker to a curvilinear wall and subsequently to a linear wall.

In a different application, it would be desirable for the musician to be able to wear the speaker in order to have an immediate acoustic feedback.

### OBJECT OF THE INVENTION

The object of the present invention is to overcome the drawbacks of the known art by proposing a portable acoustic speaker having a shape that can be adapted to the circumstances.

### SUMMARY OF THE INVENTION

The above purposes are achieved by a portable speaker with flexible geometry according to at least one of the annexed claims.

A first advantage consists in the possibility of adapting the speaker to supports of different geometry.

A second advantage consists in the possibility for a musician to wear the speaker in the form of a belt or shoulder strap.

### LIST OF THE DRAWINGS

The above and further advantages will be understood by any person skilled in the branch from the ensuing description and from the annexed drawings, wherein:

FIG. 1 shows an exploded view of the speaker of the invention;

FIG. 2 shows the speaker of FIG. 1 in curvilinear configuration;

FIG. 3 shows the speaker of FIG. 1 in rectilinear configuration; and

FIG. 4 shows the speaker of FIG. 1 provided with a shoulder strap.

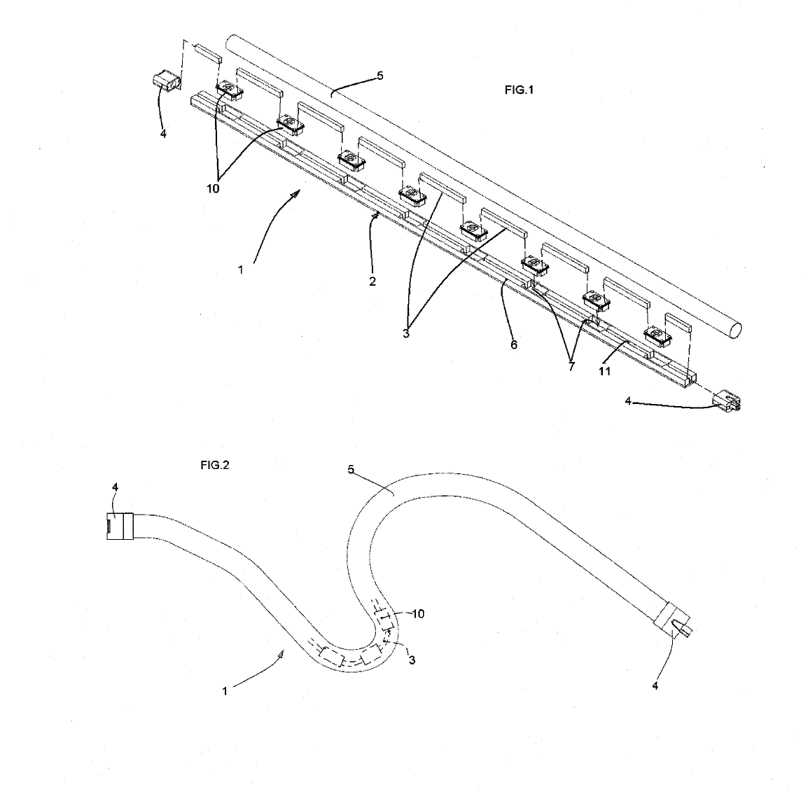

### DETAILED DESCRIPTION

With reference to the drawings, described herein is an acoustic speaker 1 comprising a plurality of loudspeakers 10 arranged in line and connected together by means of intermediate electrical connections, for example flexible cables, provided with end connections 4 for connection to an acoustic system and/or to further speakers in the case of a modular arrangement.

The connections 3, 4 are of a type in itself known for connection of acoustic speakers, and are hence not described in greater detail.

Preferably, the connections 3 are arranged within a protective sheath, which is also flexible.

In a preferred embodiment, according to the invention, the loudspeakers 10 are housed within seats 7 of a flexible elongated support 2 made of an elastic material, for example rubber or the like, and coated with an external flexible sheath 5 provided for protection and containment of the loudspeakers and the connections.

Preferably, the support 2 is moreover provided with further seats 11 for housing the connections 3.

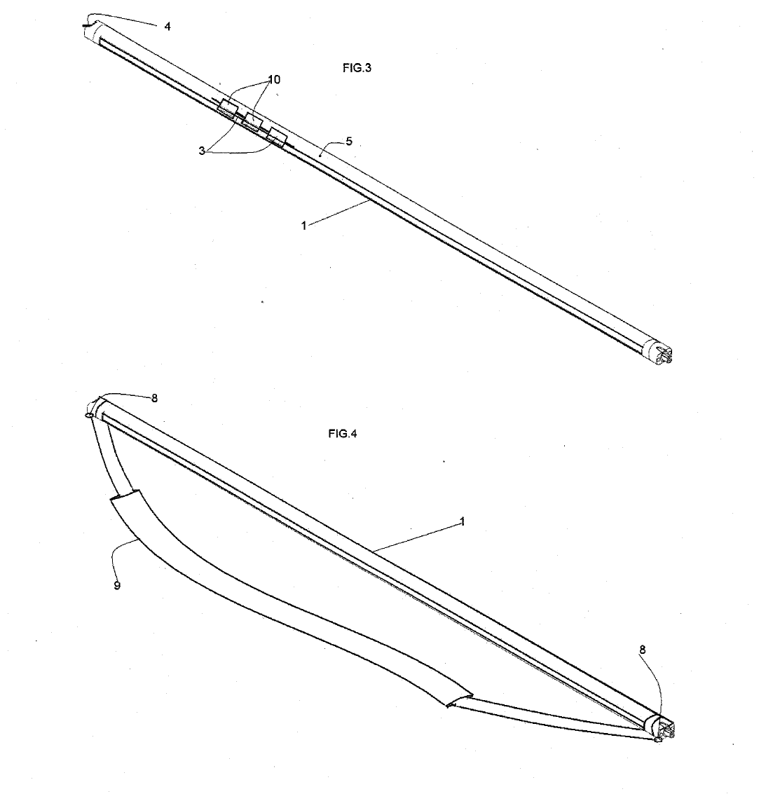

The speaker presents numerous advantages because it is able to assume in a flexible way curved conformations (FIG. 3) and hence adapt to applications that require a non-rectilinear shape of the speaker.

In addition, the speaker may be sized for portable use and in this case may comprise fixing means 8, for example hooks arranged at the ends of the speaker, for connecting belts or straps 9 that can be worn by a user (FIG. 4), for example a musician.

The present invention has been described according to preferred embodiments, but equivalent variants may be devised without thereby departing from the sphere of protection granted.

1. A speaker(1), comprising:
a plurality of loudspeakers (10);
flexible means (2) for in-line connection of the loudspeakers;
first intermediate electrical connections (3) between said loudspeakers;
terminal electrical interfaces (4); and
a flexible sheath (5) for external coating of said loudspeakers and said flexible supporting means.

2. The speaker according to claim 1, wherein said flexible connection means comprise a common support (6).

3. The speaker according to claim 1, wherein said common support is constituted by an elongated body made of elastic material (6) provided with seats (7) for housing said loudspeakers precisely.

4. The speaker according to claim 1, wherein said flexible means are constituted by an elongated body made of elastic material (6) provided with seats (11) for housing said connections precisely.

5. The speaker according to claim 1, wherein said sheath is a hollow tubular body made of flexible material.

6. The speaker according to claim 1, comprising fixing means (8) consisting of belts (9) or straps that can be worn to render the speaker portable for a user.

7. The speaker according to claim 1, wherein said end connections (4) are connections arranged for connecting a number of speakers in a modular way.

8. The speaker according to claim 2, wherein said flexible means are constituted by an elongated body made of elastic material (6) provided with seats (11) for housing said connections precisely.

9. The speaker according to claim 3, wherein said flexible means are constituted by an elongated body made of elastic material (6) provided with seats (11) for housing said connections precisely.

10. The speaker according to claim 2, wherein said sheath is a hollow tubular body made of flexible material.

11. The speaker according to claim 3, wherein said sheath is a hollow tubular body made of flexible material.

12. The speaker according to claim 4, wherein said sheath is a hollow tubular body made of flexible material.

13. The speaker according to claim 2, comprising fixing means (8) consisting of belts (9) or straps that can be worn to render the speaker portable for a user.

14. The speaker according to claim 3, comprising fixing means (8) consisting of belts (9) or straps that can be worn to render the speaker portable for a user.

15. The speaker according to claim 4, comprising fixing means (8) consisting of belts (9) or straps that can be worn to render the speaker portable for a user.

16. The speaker according to claim 5, comprising fixing means (8) consisting of belts (9) or straps that can be worn to render the speaker portable for a user.

17. The speaker according to claim 2, wherein said end connections (4) are connections arranged for connecting a number of speakers in a modular way.

18. The speaker according to claim 3, wherein said end connections (4) are connections arranged for connecting a number of speakers in a modular way.

19. The speaker according to claim 4, wherein said end connections (4) are connections arranged for connecting a number of speakers in a modular way.

20. The speaker according to claim 5, wherein said end connections (4) are connections arranged for connecting a number of speakers in a modular way.
